(19) United States
(12) Patent Application Publication
(10) Pub. No.: US 2009/0015577 A1
(43) Pub. Date: Jan. 15, 2009

(54) Driving method of flat panel display apparatus

(75) Inventors: Norihito Nishimoto, Gifu (JP); Hiroyuki Ikeda, Gifu (JP); Yasunobu Kato, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignees: Sony Corporation, Tokyo (JP); Field Emission Technologies, Inc., Tokyo (JP)

(21) Appl. No.: 12/213,503

(22) Filed: Jun. 20, 2008

(30) Foreign Application Priority Data
Jul. 10, 2007 (JP) 2007-181021

(51) Int. Cl. G06F 3/038

(52) U.S. Cl. 345/211

(57) ABSTRACT

A driving method of a flat panel display apparatus of a line-sequential driving system in which the display apparatus has N first wirings extending in a first direction, M second wirings extending in a second direction different from the first direction, and image display portions formed in overlapped regions of the first wirings and the second wirings, and the first to Nth first wirings are sequentially selected. A predetermined voltage is applied to each of the M second wirings for a period of time until the first first wiring is selected after the Nth first wiring was selected.

### CROSS REFERENCES TO RELATED APPLICATIONS

The present invention contains subject matter related to Japanese Patent Application JP 2007-181021 filed in the Japanese Patent Office on Jul. 10, 2007, the entire contents of which being incorporated herein by reference.

### BACKGROUND OF THE INVENTION

1. Field of the Invention

The invention relates to a driving method of a flat panel display apparatus and, more particularly, to a driving method based on a line-sequential driving system of a flat panel display apparatus.

2. Description of the Related Arts

Various kinds of display apparatuses of a flat panel type have been examined as image display apparatuses in place of a cathode ray tube (CRT). As such flat panel display apparatuses, a liquid crystal display apparatus (LCD), an electroluminescence display apparatus (ELD), and a plasma display apparatus (PDP) can be mentioned as examples. Development of a flat panel display apparatus in which electron emitting devices have been assembled is also being progressed. As electron emitting devices, a cold cathode electric field electron emitting device, a metal/insulating film/metal type device (also referred to as an MIM device), and a surface conduction electron emitting device can be mentioned.

As one of driving methods in those flat panel display apparatuses, a line-sequential driving system can be mentioned. That is, the flat panel display apparatus of such a driving system generally has: N first wirings (scanning lines) extending in a first direction; M second wirings (signal lines) extending in a second direction different from the first direction; and image display portions formed in overlapped regions of the first wirings (scanning lines) and the second wirings (signal lines). The first to Nth first wirings are sequentially selected. For example, when the nth (n is any one of 1, 2, . . . , and N) first wiring is selected, a voltage which specifies a luminance in the image display portion is applied to each of the M second wirings. An image having a desired gradation can be displayed in each of the image display portions.

In recent years, the realization of multi-pixels (high resolution) of the flat panel display apparatus has been being progressed more and more. In association with it, there is such a tendency that a length of second wiring (signal line) becomes long and an electrostatic capacitance in the second wiring increases. There is also such a tendency that a frameraterises. A dullness of a wave form of a signal which propagates in the second wiring (signal line) increases (refer to a schematic diagram of FIG. 1C) due to such an increase in electrostatic capacitance in the second wiring and the high frame rate and it becomes one of causes of a deterioration in display image quality in the flat panel display apparatus. The schematic diagram of FIG. 1C will be described hereinafter.

As a method of solving such a problem, a method whereby the second wirings (signal lines) are divided into two parts or into multi-parts of three or more parts has been well known in, for example, Japanese Patent Application Laid-Open No. 2000-020005, Japanese Patent Application Laid-Open No. 2000-029432, or Japanese Patent Application Laid-Open No. 2003-036047.

It is now assumed that the second wirings (signal lines) have been divided into two parts. In such a case, as shown in a conceptual diagram of FIG. 1A, a flat panel display apparatus has:

(A) a first wiring group (113₁, 113₂) constructed by N first wirings extending in a first direction;

(B) a second wiring group (111₁, 111₂) constructed by (2×M) second wirings in such a manner that M virtual second wirings extending in a second direction different from the first direction are divided into two parts along the first direction; and

(C) image display portions EA formed in overlapped regions of the first wirings and the second wirings.

Further, in this case, the first wiring group is constructed by: a first first wiring group 113₁ having N₁ first wirings; and a second first wiring group 113₂ having N₂ (where, N=N₁+N₂) first wirings. The second wiring group is constructed by: a first second wiring group 111₁ having M second wirings which overlap the first first wiring group 113₁; and a second second wiring group 111₂ having M second wirings which overlap the second first wiring group 113₂.

According to the line-sequential driving system in the flat panel display apparatus with such a construction, for example, the first to N₁-th first wirings in the first first wiring group 113₁ are sequentially selected and, subsequently, the first to N₂-th first wirings in the second first wiring group 113₂ are sequentially selected. The first first wiring in the second first wiring group 113₂ is adjacent to the N₁-th first wiring in the first first wiring group 113₁.

In the following description, the n₁-th (where, n₁=1, 2, . . . , N₁) first wiring in the first first wiring group 113₁ is called a (1, n₁)-th first wiring. The n₂-th (where, n₂=1, 2, . . . , N₂) first wiring in the second first wiring group 113₂ is called a (2, n₂)-th first wiring. The n₁-th horizontal scanning period during which the n₁-th first wiring has been selected in the first first wiring group 113₁ is called a (1, n₁)-th horizontal scanning period. The (N₁+n₂)-th horizontal scanning period during which the n₂-th first wiring in the second first wiring group 113₂ has been selected is called a (2, n₂)-th horizontal scanning period. Further, when a voltage which specifies a luminance in the image display portion is applied to each of the M second wirings in the first second wiring group 111₁ in the (1, n₁)-th horizontal scanning period, such a voltage is called a signal voltage Vₘ(1, n₁). When a voltage which specifies a luminance in the image display portion is applied to each of the M second wirings in the second second wiring group 111₂ in the (2, n₂)-th horizontal scanning period, such a voltage is called a signal voltage Vₘ(2, n₂). A suffix “m” denotes the m-th (where, m=1, 2, . . . , M) second wiring.

### SUMMARY OF THE INVENTION

In the foregoing line-sequential driving system, the resolution of the flat panel display apparatus is rising more and more and problems, which will be described hereinbelow, occur due to a further increase in electrostatic capacitance in the second wiring and the realization of a further high frame rate. That is, after the end of the (1, N₁)-th horizontal scanning period, in the (2, 1)-th horizontal scanning period as a next horizontal scanning period, the (2, 1)-th first wiring is selected in the second first wiring group 113₂. At the same time, a signal voltage Vₘ(2, 1) as a voltage which specifies the luminance in the image display portion is applied to each of the M second wirings in the second second wiring group 111₂.

In the (1, N₁)-th horizontal scanning period just before the timing when the signal voltage Vₘ(2, 1) is applied to each of the M second wirings, although a signal voltage Vₘ(1, N₁) is applied to the first second wiring group 111₁, the second second wiring group 111₂ is in a state where no voltage is applied. Therefore, in the (2, 1)-th horizontal scanning period, when the signal voltage Vₘ(2, 1) is applied to each of the M second wirings in the second second wiring group 111₂, a dullness of a waveform of the signal voltage Vₘ(2, 1) which propagates in the second wiring (signal line) increases because the second wiring is charged by the signal voltage Vₘ(2, 1).

Thus, a large difference occurs between the display state in the image display portion in the (1, N₁)-th horizontal scanning period and the display state in the image display portion in the (2, 1)-th horizontal scanning period and a deterioration in display image quality in the flat panel display apparatus occurs. Particularly, since the (1, N₁)-th first wiring and the (2, 1)-th first wiring are ordinarily located in a center portion of an image display region of the flat panel display apparatus, such a difference is liable to occur.

Even in the case where the second wiring group is not divided into two parts, after completion of the last horizontal scanning period, when the first horizontal scanning period in a next new display frame starts, the signal voltage is applied to each of the M second wirings. However, since a charging state of the M second wirings at this time differs from a charging state of the M second wirings after the second horizontal scanning period, a large difference occurs between the display state in the image display portion in the first horizontal scanning period and the display state in the image display portion in the second horizontal scanning period and the deterioration in display image quality in the flat panel display apparatus occurs.

It is, therefore, desirable to provide a driving method based on a line-sequential driving system of a flat panel display apparatus, in which a difference is difficult to occur in a display state between scanning lines.

According to an embodiment of the present invention, there is provided a driving method of a flat panel display apparatus of a line-sequential driving system, in which the display apparatus comprises:

(A) a first wiring group having N first wirings extending in a first direction;

(B) a second wiring group constructed by (2×M) second wirings in such a manner that M virtual second wirings extending in a second direction different from the first direction are divided into two parts along the first direction; and

(C) image display portions formed in overlapped regions of the first wirings and the second wirings,

the first wiring group is constructed by a first first wiring group having N₁ first wirings and a second first wiring group having N₂ (where, N=N₁+N₂) first wirings,

the second wiring group is constructed by a first second wiring group having M second wirings which overlap the first first wiring group and a second second wiring group having M second wirings which overlap the second first wiring group, and

the first to N₁-th first wirings in the first first wiring group are sequentially selected and, subsequently, the first to N₂-th first wirings in the second first wiring group are sequentially selected,

whereby when at least the N₁-th first wiring is selected in the first first wiring group and a voltage which specifies a luminance in the image display portion is applied to each of the M second wirings in the first second wiring group, a predetermined voltage is applied to each of the M second wirings in the second second wiring group.

The (2, 1)-th first wiring is adjacent to the (1, N₁)-th first wiring. When at least the (1, N₁)-th first wiring is selected and a signal voltage Vₘ(1, N₁) is applied to each of the M second wirings, a predetermined voltage is applied to each of the M second wirings in the second second wiring group. However, as a state where the predetermined voltage is applied to each of the M second wirings in the second second wiring group, more specifically speaking, not only timing when the (1, N₁)-th first wiring is selected [that is, the (1, N₁)-th horizontal scanning period] but also timing when the (1, N₁-1)-th first wiring is selected [that is, the (1, N₁-1)-th horizontal scanning period], timing when the (1, N₁-2)-th first wiring is selected [that is, the (1, N₁-2)-th horizontal scanning period], timing when the (1, N₁-3)-th first wiring is selected [that is, the (1, N₁-3)-th horizontal scanning period], and the like can be mentioned.

In the driving method of the flat panel display apparatus according to an embodiment of the invention, the predetermined voltage can be constructed in such a manner that

(1) it is a voltage equal to the voltage [Vₘ(1, N₁)] when the N₁-th first wiring is selected in the first first wiring group and the voltage which specifies the luminance in the image display portion is applied to each of the M second wirings in the first second wiring group,

(2) it is a voltage equal to the voltage [Vₘ(2, 1)] when the first first wiring is selected in the second first wiring group and the voltage which specifies the luminance in the image display portion is applied to each of the M second wirings in the second second wiring group, or

(3) it is a preset dummy voltage V_{Dummy} (for example, signal voltage for providing the highest luminance).

According to another embodiment of the present invention, there is provided a driving method of a flat panel display apparatus of a line-sequential driving system, in which the display apparatus comprises:

(A) N first wirings extending in a first direction;

(B) M second wirings extending in a second direction different from the first direction; and

(C) image display portions formed in overlapped regions of the first wirings and the second wirings, and

the first to Nth first wirings are sequentially selected,

where by a predetermined voltage is applied to each of the M second wirings for a period of time until the first first wiring is selected after the Nth first wiring was selected.

The Nth first wiring is selected and, subsequently, the first first wiring is selected.

In the driving method of the flat panel display apparatus according to another embodiment of the invention, the predetermined voltage can be constructed in such a manner that

(1) it is a voltage equal to the voltage [Vₘ(N)] when the Nth first wiring is selected and the voltage which specifies the luminance in the image display portion is applied to each of the M second wirings,

(2) it is a voltage equal to the voltage [Vₘ(1)] when the first first wiring is selected and the voltage which specifies the luminance in the image display portion is applied to each of the M second wirings, or

(3) it is the preset dummy voltage V_{Dummy} (for example, signal voltage for providing the highest luminance). A suffix “m” denotes the m-th (where, m=1, 2, . . . , M) second wiring and a numeral shown in parentheses denotes which designated number of first wiring has been selected or the horizontal scanning period is a period of which designated number.

In the driving method of the flat panel display apparatus according to the embodiments of the invention including the foregoing preferred constructions (those driving methods are generally merely called a driving method of the invention hereinbelow), as such flat panel display apparatuses, specifically speaking, a liquid crystal display apparatus (LCD), an electroluminescence display apparatus (ELD), a plasma display apparatus (PDP), and a flat panel display apparatus in which electron emitting devices have been assembled can be mentioned. As electron emitting devices, for example, the cold cathode electric field electron emitting device of a spint type, a flat type, an edge type, a plane type, or the like, the MIM device, and the surface conduction electron emitting device can be mentioned.

In the driving method according to the embodiments of the invention, as combinations of values of (M, N), specifically speaking, for example, several kinds of resolution for image display such as (1920, 1080), (1920, 1035), (1024, 768), (800, 600), (640, 480), (720, 480), (1280, 960), (1280, 1024), and the like can be mentioned. However, they are not limited to those values. In the case of a color display, it is sufficient to set N to 3 times. As values of N₁ and N₂, although N₁ may be set to a quotient of (N/2) or N₂ may be set to a quotient of (N/2), they are not limited to those values. From a viewpoint of simplification of a structure of the flat panel display apparatus, it is preferable that the first direction and the second direction cross perpendicularly.

In the case where the flat panel display apparatus is a cold cathode electric field electron emitting display apparatus as a flat panel display apparatus in which cold cathode electric field electron emitting devices have been assembled, the cold cathode electric field electron emitting display apparatus can be constructed as follows.

A cathode panel and an anode panel are joined in their peripheral edge portions.

The cathode panel comprises:

(a) supporting plate;

(b) a plurality of belt-shaped cathode electrodes formed on the supporting plate;

(c) an insulating layer formed on the supporting plate and the cathode electrodes;

(d) a plurality of belt-shaped gate electrodes formed on the insulating layer; and

(e) electron emitting regions locating in overlapped regions of the gate electrodes and the cathode electrodes,

the anode panel is constructed by a substrate and phosphor regions and anode electrodes formed on the substrate in correspondence to the electron emitting regions, and

one or a plurality of cold cathode electric field electron emitting devices (herein below, there is a case where they are abbreviated to field emission devices) is arranged in each of the electron emitting regions.

A type of field emission device is not particularly limited but a spint type field emission device (field emission device in which a conical electron emitting portion is formed on a cathode electrode locating in a bottom portion of an opening portion) and a flat type field emission device (field emission device in which an almost flat electron emitting portion is formed on a cathode electrode locating in a bottom portion of an opening portion) can be mentioned.

In the cold cathode electric field electron emitting display apparatus, a strong electric field caused by voltages applied to the cathode electrode and the gate electrode is applied to the electron emitting portion, so that electrons are emitted from the electron emitting portion by a quantum tunnel effect. The electrons are attracted to the anode panel by the anode electrode provided for the anode panel and collide with the phosphor region. As a result of the collision of the electrons to the phosphor region, the phosphor region emits the light and the emitted light can be recognized as an image.

In the cold cathode electric field electron emitting display apparatus, the cathode electrode is connected to a cathode electrode control circuit, the gate electrode is connected to a gate electrode control circuit, and the anode electrode is connected to an anode electrode control circuit, respectively. Those control circuits can be formed by well-known circuits. At the time of the actual operation, a voltage (anode voltage) V_{A} which is applied to the anode electrode from the anode electrode control circuit is ordinarily constant and can be set to, for example, 5 to 15 kvolts (kilovolts). Or, assuming that a distance between the anode panel and a cathode panel is set to do (where, 0.5 mm≦d₀≦10 mm), it is desirable that a value of V_{A}/d₀ (unit: kvolts/mm) lies within a range from 0.5 or more to 20 or less, preferably, a range from 1 or more to 10 or less, much preferably, a range from 4 or more to 8 or less.

The field emission device can be generally manufactured by the following method:

(1) a step of forming the cathode electrode onto the supporting plate;

(2) a step of forming the insulating layer onto a whole surface (on the supporting plate and the cathode electrode);

(3) a step of forming the gate electrode onto the insulating layer;

(4) a step of forming the opening portion in the potions of the gate electrode and the insulating layer in the overlapped region of the cathode electrode and the gate electrode and allowing the cathode electrode to be exposed in the bottom portion of the opening portion; and

(5) a step of forming the electron emitting portion onto the cathode electrode locating in the bottom portion of the opening portion.

Or, the field emission device can be also manufactured by the following method:

(1) a step of forming the cathode electrode onto the supporting plate;

(2) a step of forming the electron emitting portion onto the cathode electrode;

(3) a step of forming the insulating layer onto a whole surface (on the supporting plate and the electron emitting portion or on the supporting plate, the cathode electrode, and the electron emitting portion);

(4) a step of forming the gate electrode on to the insulating layer; and

(5) a step of forming the opening portion in the potions of the gate electrode and the insulating layer in the overlapped region of the cathode electrode and the gate electrode and allowing the electron emitting portion to be exposed in the bottom portion of the opening portion.

In the spint type field emission device, as a material forming the electron emitting portion, a material of at least one kind selected from a group including molybdenum, a molybdenum alloy, tungsten, a tungsten alloy, titanium, a titanium alloy, niobium, a niobium alloy, tantalum, a tantalum alloy, chromium, a chromium alloy, and silicon (polysilicon, amorphous silicon) containing impurities can be mentioned. The electron emitting portion of the spint type field emission device can be formed by various physical vapor phase growing method (PVD method) such as sputtering method or vacuum evaporation depositing method or by various chemical vapor phase growing method (CVD method).

In the flat type field emission device, as a material forming the electron emitting portion, it is preferable to form it from a material whose work function Φ is smaller than that of the material forming the cathode electrode. It is sufficient to decide which kind of material is selected on the basis of the work function of the material forming the cathode electrode, a potential difference between the gate electrode and the cathode electrode, a magnitude of an emitted electron current density which is requested, and the like. Or, as a material forming the electron emitting portion, it may be properly selected from such materials that a secondary electron gain δ of such a material is larger than that of a conductive material forming the cathode electrode. In the flat type field emission device, as a particularly preferred material forming the electron emitting portion, carbon, specifically speaking, amorphous diamond, graphite, a carbon-nanotube structure (carbon-nanotube and/or graphite-nanofiber), ZnO whiskers, MgO whiskers, SnO₂ whiskers, MnO whiskers, Y₂O₃ whiskers, NiO whiskers, ITO whiskers, In₂O₃ whiskers, or Al₂O₃ whiskers can be mentioned. It is not exactly necessary that the material forming the electron emitting portion has conductivity.

As materials forming the cathode electrode, the gate electrode, and a focusing electrode, which will be described herein after, for example, the following materials can be mentioned: a metal such as aluminum Al, tungsten W, niobium Nb, tantalum Ta, molybdenum Mo, chromium Cr, copper Cu, gold Au, silver Ag, titanium Ti, nickel Ni, cobalt Co, zirconium Zr, iron Fe, platinum Pt, zinc Zn, or the like; an alloy (for example, MoW) or a compound (for example, nitride such as TiN or the like or silicide such as WSi₂, MoSi₂, TiSi₂, TaSi₂, or the like) containing those metal elements; a semiconductor of silicon Si or the like; a carbon thin film such as diamond or the like; and a conductive metal oxide such as ITO (indium oxide—tin), indium oxide, zinc oxide, or the like. As a method of forming those electrodes, for example, there can be mentioned: a combination of an evaporation depositing method such as electron beam evaporation depositing method or thermal filament evaporation depositing method, a sputtering method, a CVD method, or an ion plating method and an etching method; various printing methods such as screen printing method, ink-jet printing method, and metal mask printing method; a plating method (electroplating method, electroless plating method); a lift-off method; a laser ablation method; a sol-gel method; or the like. According to the various printing methods or the plating method, for example, the belt-shaped cathode electrode and gate electrode can be directly formed.

As materials forming the insulating layer and an interlayer insulating layer, which will be described hereinafter, the following materials can be solely or properly combined and used: an SiO₂ system material such as SiO₂, BPSG, PSG, BSG, AsSG, PbSG, SiON, SOG (spin-on glass), glass of a low melting point, a glass paste; an SiN system material; and an insulative resin such as polyimide or the like. To form the insulating layer and the inter layer insulating layer, a well-known process such as CVD method, coating method, sputtering method, various printing methods, or the like can be used.

As a plane shape of a first opening portion (opening portion formed in the gate electrode) or a second opening portion (opening portion formed in the insulating layer) (shape which is obtained when the opening portion is cut at a virtual plane that is parallel with a surface of the supporting plate), an arbitrary shape such as circle, ellipse, rectangle, polygon, rectangle with rounded sides, polygon with rounded sides, or the like can be used. The first opening portion can be formed by, for example, an anisotropic etching, an isotropic etching, or a combination of the anisotropic etching and the isotropic etching. Or, the first opening portion can be also directly formed in dependence on the forming method of the gate electrode. The second opening portion can be also similarly formed by, for example, the anisotropic etching, the isotropic etching, or the combination of the anisotropic etching and the isotropic etching.

In the field emission device, although depending on the structure of the field emission device, one electron emitting portion may exist in one opening portion, a plurality of electron emitting portions may exist in one opening portion, or a construction in which a plurality of first opening portions are provided for the gate electrode, one second opening portion communicated with such a first opening portion is provided for the insulating layer, and one or a plurality of electron emitting portions exist in one second opening portion provided for the insulating layer may be used.

In the field emission device, a resistor film may be formed between the cathode electrode and the electron emitting portion. By providing the resistor film, the operation of the field emission device can be stabilized and electron emitting characteristics can be uniformed. As a material forming the resistor film, for example, there can be mentioned: a carbon system material such as silicon carbide SiC or SiCN; a semiconductor material such as SiN, amorphous silicon, or the like; or a metal oxide of a high melting point or a metal nitride of a high melting point such as ruthenium oxide RuO₂, tantalum oxide, tantalum nitride, or the like. As a method of forming the resistor film, for example, the sputtering method, CVD method, or various printing methods can be mentioned. It is sufficient that an electric resistance value per electron emitting portion is set to a value within a range of about 1×10⁶ to 1×10¹¹ Ω, preferably, a few gigaΩ.

As a supporting plate forming the cathode panel or a substrate forming the anode panel, a glass substrate, a glass substrate formed with a insulating film on its surface, a quartz substrate, a quartz substrate formed with a insulating film on its surface, or a semiconductor substrate formed with a insulating film on its surface can be mentioned. From a viewpoint of reduction of manufacturing costs, it is preferable to use the glass substrate or the glass substrate formed with the insulating film on the surface. As a glass substrate, for example, glass of a high strain point, low-alkali glass, no-alkali glass, soda glass (Na₂O·CaO·SiO₂), borosilicate glass (Na₂O·B₂O₃·SiO₂), forsterite (2MgO·SiO₂), or lead glass (Na₂O·PbO·SiO₂) can be mentioned.

In the flat panel display apparatus, as an example of constructions of the anode electrode and the phosphor region, (1) a construction in which the anode electrode is formed on the substrate and the phosphor region is formed on the anode electrode or (2) a construction in which the phosphor region is formed on the substrate and the anode electrode is formed on the phosphor region can be mentioned. In the construction of (1), what is called a metal-backed film which is conductive to the anode electrode may be formed on the phosphor region. In the construction of (2), the metal-backed film may be formed on the anode electrode. The metal back itself may have an anode electrode function.

The anode electrode may be formed by one anode electrode as a whole or can be also formed by a plurality of anode electrode units. In the latter case, it is preferable that the anode electrode unit and the anode electrode unit are electrically connected by an anode electrode resistor layer. As a material forming the anode electrode resistor layer, there can be mentioned: a carbon system material such as carbon, silicon carbide SiC, or SiCN; an SiN system material; a metal oxide of a high melting point or a metal nitride of a high melting point such as ruthenium oxide RuO₂, tantalum oxide, tantalum nitride, chromium oxide, titaniumoxide, or the like; a semiconductor material such as amorphous silicon; and ITO. A stable desired sheet resistance value can be also realized by a combination of a plurality of films obtained by laminating a carbon thin film of a small resistance value onto an SiC resistance film. A sheet resistance value of the anode electrode resistor layer can be set to a value, for example, within a range from 1×10⁻¹ Ω/□ to 1×10¹⁰ Ω/□, preferably, a range from 1×10³ Ω/□ to 1×10⁸ Ω/□. It is sufficient that the number Q of anode electrode units is equal to 2 or more. For example, assuming that the total number of columns of the phosphor regions which have rectilinearly been arranged is equal to q, Q=q or q may be set to q=k·Q (k is an integer of 2 or more; preferably, 10≦k≦100, much preferably, 20≦k≦50). Q can be also set to a value obtained by adding “1” to the number of pixels or the number of spacers arranged at regular intervals. Q maybe set to a value which coincides with the number of pixels or the number of sub-pixels or can be also set to a value of a fraction of an integer of the number of pixels or the number of sub-pixels. A size of each anode electrode unit may be set to be identical irrespective of the position of the anode electrode unit or those sizes can be also made different in dependence on the position of the anode electrode unit. The anode electrode resistor layer can be also formed on one anode electrode as a whole.

It is sufficient to form the anode electrode (containing the anode electrode unit) by using a conductive material layer. As a method of forming the conductive material layer, for example, there can be mentioned: an evaporation depositing method such as electron beam evaporation depositing method or thermal filament evaporation depositing method; various PVD methods such as sputtering method, ion plating method, and laser ablation method; various CVD methods; various printing methods; a metal mask printing method; a lift-off method; a sol-gel method; and the like. That is, the anode electrode can be formed by forming a conductive material layer made of a conductive material and patterning the conductive material layer on the basis of a lithography technique and an etching technique. Or, the anode electrode can be also obtained by forming the conductive material through a mask or a screen having a pattern of the anode electrode on the basis of the PVD method or the various printing methods. The anode electrode resistor layer can be also formed by a similar method. That is, it is also possible to form the anode electrode resistor layer from a resistor material and pattern the anode electrode resistor layer on the basis of the lithography technique and the etching technique. Or, the anode electrode resistor layer can be obtained by forming the resistor material through a mask or a screen having a pattern of the anode electrode resistor layer on the basis of the PVD method or the various printing methods of the resistor material. For example, an average thickness of anode electrode on the substrate (or over the substrate) (in the case of providing partition walls as will be described hereinlater, an average thickness of anode electrode on the top face of the partition wall) can be set to a value within a range from 3×10⁻⁸ m (30 nm) to 7×10⁻⁷ m (0.7 μm), preferably, a range from 1×10⁻⁷ m (100 nm) to 4×10⁻⁷ m (0.4 μm).

As a material forming the anode electrode, for example, the following materials can be mentioned: a metal such as molybdenum Mo, aluminum Al, chromium Cr, tungsten W, niobium Nb, tantalum Ta, gold Au, silver Ag, titanium Ti, cobalt Co, zirconium Zr, iron Fe, platinum Pt, zinc Zn, or the like; an alloy or a compound (for example, nitride such as TiN or the like or silicide such as WSi₂, MoSi₂, TiSi₂, TaSi₂, or the like) containing those metal elements; a semiconductor of silicon Si or the like; a carbon thin film such as diamond or the like; and a conductive metal oxide such as ITO (indium oxide—tin), indium oxide, zinc oxide, or the like. In the case of forming the anode electrode resistor layer, it is preferable to form the anode electrode from a conductive material which does not change an electric resistance value of the anode electrode resistor layer. For example, if the anode electrode resistor layer is made of silicon carbide SiC, it is preferable to form the anode electrode from molybdenum Mo or aluminum Al.

The phosphor region may be formed from phosphor particles of a monochrome or phosphor particles of three primary colors. A layout form of the phosphor regions is, for example, a dot-shape. Specifically speaking, if the flat panel display apparatus performs a color display, a delta layout, a stripe layout, a diagonal layout, or a rectangular layout can be mentioned as an arrangement or layout of the phosphor regions. That is, one column of the phosphor regions which have rectilinearly been arranged may be constructed by a column in which the whole area is occupied by the red light emission phosphor region, a column in which the whole area is occupied by the green light emission phosphor region, and a column in which the whole area is occupied by the blue light emission phosphor region or can be also constructed by columns in which the red light emission phosphor region, green light emission phosphor region, and blue light emission phosphor region are sequentially arranged. It is now defined that the phosphor region is a phosphor region where one luminescent spot is formed in the flat panel display apparatus. One picture element (one pixel) is constructed by a set of one red light emission phosphor region, one green light emission phosphor region, and one blue light emission phosphor region. One sub-pixel is constructed by one phosphor region (one red light emission phosphor region, one green light emission phosphor region, or one blue light emission phosphor region). A gap between the adjacent phosphor regions may be embedded by a light absorbing layer (black matrix) for improving a contrast.

The phosphor regions can be formed by the following method. Radiative crystal grain compositions adjusted from radiative crystal grain are used. For example, the whole surface is coated with radiative crystal grain compositions having red photosensitivity (red light emission phosphor slurry) and the slurry is exposed and developed, thereby forming the red light emission phosphor region. Subsequently, the whole surface is coated with radiative crystal grain compositions having green photosensitivity (green light emission phosphor slurry) and the slurry is exposed and developed, thereby forming the green light emission phosphor region. Further, the whole surface is coated with radiative crystal grain compositions having blue photosensitivity (blue light emission phosphor slurry) and the slurry is exposed and developed, thereby forming the blue light emission phosphor region. Or, the phosphor regions may be formed by the following method. After the whole surface is sequentially coated with the red light emission phosphor slurry, green light emission phosphor slurry, and blue light emission phosphor slurry, the phosphor slurries are sequentially exposed and developed, thereby forming the phosphor regions. The phosphor regions can be also formed by a screen printing method, an ink-jet printing method, a float coating method, a sedimentation coating method, a phosphor film transfer method, or the like. An average thickness of phosphor region on the substrate is not particularly limited but it is desirable to set the average thickness to a range from 3 to 20 μm, preferably, a range from 5 to 10 μm. As a phosphor material forming the radiative crystal grain, a proper one of the well-known phosphor material in the related art can be selected and used. In the case of the color display, it is preferable to combine such phosphor materials that color purities are close to three primary colors which are specified in the NTSC, a good white balance is obtained when the three primary colors are mixed, an afterglow time is short, and afterglow times of the three primary colors are almost equal.

It is preferable that the light absorbing layer which absorbs the light from the phosphor regions is formed between the adjacent phosphor regions or between the partition wall and the substrate from a viewpoint of improvement of the contrast of the display image. The light absorbing layer functions as what is called a black matrix. As a material forming the light absorbing layer, it is preferable to select a material which can absorb 90% or more of the light from the phosphor regions. As such a material, the following materials can be mentioned: carbon; a metal thin film (for example, chromium, nickel, aluminum, molybdenum, or the like, or their alloy); a metal oxide (for example, chromium oxide); a metal nitride (for example, chromium nitride); a heat resistant organic resin; a glass paste; a glass paste containing a black pigment or conductive particles of silver or the like; and the like. Specifically speaking, for example, a photosensitive polyimide resin, chromium oxide, or a chromium oxide/chromium laminate film can be mentioned. In the chromium oxide/chromium laminate film, the chromium film is come into contact with the substrate. As a method of forming the light absorbing layer, for example, the following methods can be mentioned: a combination of the vacuum evaporation depositing method or sputtering method and the etching method; a combination of the vacuum evaporation depositing method, sputtering method, or spin coating method and the lift-off method; various printing method; lithography technique; and the like. The light absorbing layer can be formed by the proper method selected from those methods in accordance with the materials which are used.

It is preferable to provide the partition walls in order to prevent such a phenomenon that the electron recoiled from the phosphor region or the secondary electron emitted from the phosphor region enters another phosphor region and what is called an optical crosstalk (color turbidity) occurs or in order to prevent such a phenomenon that the electron recoiled from the phosphor region or the secondary electron emitted from the phosphor region collides with another phosphor region.

As a method of forming the partition walls, for example, a screen printing method, a dry film method, a photosensing method, a casting method, and a sand blast forming method can be mentioned. The screen printing method is a method whereby an opening has been formed in a portion of a screen corresponding to a portion where the partition wall should be formed, a partition wall forming material on the screen is allowed to pass through the opening by using a squeegee, a partition wall forming material layer is formed onto the substrate, and thereafter, the partition wall forming material layer is baked. The dry film method is a method whereby a photosensitive film is laminated onto the substrate, the photosensitive film in a partition wall forming scheduled portion is removed by exposure and development, and the partition wall forming material is buried into an opening formed by the removal and baked. The photosensitive film is burned and removed by the baking. The partition wall forming material buried in the opening remains and becomes the partition wall. The photosensing method is a method whereby a partition wall forming material layer having photosensitivity is formed onto the substrate and the partition wall forming material layer is patterned by exposure and development and, thereafter, baked (hardened). The casting method (emboss molding method) is a method whereby a partition wall forming material layer made of a paste-like organic material or inorganic material is extruded onto the substrate from a die (cast), thereby forming the partition wall forming material layer, and thereafter, the partition wall forming material layer is baked. The sand blast forming method is a method whereby a partition wall forming material layer is formed onto the substrate by using, for example, the screen printing method or metal mask printing method, a roll coater, a doctor blade, a nozzle emitting coater, or the like and dried, thereafter, a portion of the partition wall forming material layer where the partition wall should be formed is coated with a mask layer, and subsequently, the exposed portion of the partition wall forming material layer is removed by a sandblast method. After the partition wall was formed, the partition wall top face may be flattened by grinding the partition wall.

As a plane shape of the portion which surrounds the phosphor region in the partition wall (corresponding to an inside profile of a projection image of a side surface of the partition wall; a kind of opening region), for example, a rectangular shape, a circular shape, an elliptic shape, an oval shape, a triangular shape, a polygonal shape of a pentagon or more, a triangular shape with rounded sides, a rectangular shape with rounded sides, a polygon with rounded sides, or the like can be mentioned. By arranging those plane shapes (plane shapes of the opening regions) in a 2-dimensional matrix form, the lattice-shaped partition walls are formed. As a layout in the 2-dimensional matrix form, for example, the plane shapes may be arranged like a pattern of two pairs of intersecting parallel lines or a zigzag pattern.

As a partition wall forming material, for example, a photosensitive polyimide resin, lead glass colored in black by a metal oxide such as cobalt oxide or the like, SiO₂, or a glass paste of a low melting point can be mentioned. A protecting layer (made of, for example, SiO₂, SiON, or AlN) adapted to prevent such a phenomenon that the electron beam collides with the partition wall and a gas is emitted from the partition wall may be formed on the surface (top face or side surface) of the partition wall.

A focusing electrode may be equipped for the field emission device. That is, for example, the field emission device may be constructed by a field emission device in which an interlayer insulating layer is further provided on the gate electrode and the insulating layer and the focusing electrode is provided on the interlayer insulating layer or a field emission device in which the focusing electrode is provided over the gate electrode. The focusing electrode is an electrode in which a trajectory of the emission electron which is emitted from the opening portion and progresses toward the anode electrode is focused, thereby enabling the luminance to be improved and enabling the optical crosstalk between the adjacent pixels to be prevented. The focusing electrode is particularly effective in the cold cathode electric field electron emitting display apparatus of what is called a high voltage type in which a potential difference between the anode electrode and the cathode electrode is on the order of a few kilovolts or more and a distance between the anode electrode and the cathode electrode is relatively long. A relative negative voltage (for example, 0 volt) is applied to the focusing electrode from a focusing electrode control circuit. It is not always necessary that the focusing electrodes are individually formed so as to surround each of the electron emitting portions or the electron emitting regions provided in the overlapped regions where the cathode electrodes and the gate electrodes overlap. For example, the focusing electrodes may be extended along a predetermined arranging direction of the electron emitting portions or the electron emitting regions or a construction in which all of the electron emitting portions or the electron emitting regions are surrounded by one focusing electrode (that is, the focusing electrode may have a structure like one thin sheet which covers the whole effective region as a display region of a center portion which plays an actual function as a cold cathode electric field electron emitting display apparatus). Thus, a focusing effect common to a plurality of electron emitting portions or electron emitting regions can be obtained.

In the cold cathode electric field electron emitting display apparatus, since a space sandwiched between the anode panel and the cathode panel is in a vacuum state, if a spacer is not arranged between the anode panel and the cathode panel, the cold cathode electric field electron emitting display apparatus is damaged by the atmospheric pressure. As a rigid material forming the spacer, for example, ceramics or glass can be mentioned. As a ceramics material, for example, the following materials can be mentioned: an aluminum silicate compound such as mullite or the like; aluminum oxide such as alumina or the like; barium titanate; lead zirconate titanate; zirconia (zirconium oxide); cordiolight; barium borosilicate; iron silicate; a glass ceramics material; a material obtained by adding titanium oxide, chromium oxide, magnesium oxide, iron oxide, vanadium oxide, or nickel oxide to them; and the like. For instance, the materials disclosed in Japanese Patent Application Laid-Open (translation version of PCT international publication) No. 2003-524280 or the like can be also used. As a glass material, for example, glass of a high strain point, low-alkaliglass, no-alkali glass, soda glass (Na₂O·CaO·SiO₂), borosilicate glass (Na₂O·B₂O₃·SiO₂), forsterite (2MgO·SiO₂), or lead glass (Na₂O·PbO·SiO₂) can be mentioned. It is preferable to chamfer edge portions of the spacer and remove projecting portions or the like. It is sufficient that, for example, the spacer is sandwiched between the partition walls which have been provided for the anode panel and will be described hereinafter, and fixed. Or, it is sufficient that, for example, a spacer holding portion is formed on the anode panel and/or the cathode panel and the spacer is fixed by the spacer holding portion.

An antistatic film, a resistor film, or the like may be provided on the surface of the spacer. As a material which forms the antistatic film and whose secondary electron emitting coefficient is close to 1, a semimetal such as graphite or the like, oxide, boride, carbide, sulfide, nitride, and the like can be used. For example, the following materials can be mentioned: a compound containing a semimetal such as graphite or the like and semimetal elements such as MoSeₓ or the like; oxide such as CrOₓ, NdOₓ, LaₓBa₂₋ₓCuO₄, LaₓBa₂₋ₓCuO₄, LaₓY₁₋ₓCrO₃, or the like; boride such as AlBₓ, TiBₓ, or the like; carbide such as SiC or the like; sulfide such as MoSₓ, WSₓ, or the like; nitride such as BN, TiN, AlN, or the like; and the like. For instance, the materials and the like disclosed in Japanese Patent Application Laid-Open (translation version of PCT international publication) No. 2004-500688 and the like can be also used. As a material forming the resistor film, for example, ruthenium oxide RuOₓ or cermet can be mentioned. The film such as an antistatic film or the like formed on the surface of the spacer may be made of a single kind of material or can be also made of a plurality of kinds of materials. For example, the film may have a single layer structure and the layer may be made of a plurality of kinds of materials, or the film may be formed by laminating a plurality of layers and those layers may be made of different materials. Those films can be formed by the well-known methods such as sputtering method, evaporation depositing method, CVD method, screen printing method, and the like. It is sufficient that thicknesses of those films are arbitrarily set as necessary.

In the case of joining the cathode panel and the anode panel by a joint member, the whole joint member can be made of a joint material such as frit glass or the like. Or, the joint member can be also formed by: a rod-shaped or frame-shaped frame body made of a rigid material such as glass, ceramics, or the like; a joint material layer provided on the surface of the frame body on the side of the cathode panel; and a joint material layer provided on the surface of the frame body on the side of the anode panel. By properly selecting a height of frame body, the facing distance between the cathode panel and the anode panel can be set to be longer than that in the case where the whole joint member is made of the joint material. As a material forming the joint material or the joint material layer, frit glass such as B₂O₃—PbO system frit glass or SiO₂—B₂O₃—PbO system frit glass is generally used. However, what is called a metal material of a low melting point of about 120 to 400° C. may be used. As such a low melting point metal material, for example, the following materials can be mentioned: In (indium: melting point of 157° C.); an alloy of a low melting point of an indium-gold system; a high temperature solder of a tin Sn system such as Sn₈₀Ag₂₀ (melting point of 220 to 370° C.), Sn₉₅Cu₅ (melting point of 227 to 370° C.), or the like; a high temperature solder of a lead Pb system such as Pb_{97.5}Ag_{2.5} (melting point of 304° C.), Pb_{94.5}Ag_{5.5} (melting point of 304 to 365° C.), Pb_{97.5}Ag_{1.5}Sn_{1.0} (melting point of 309° C.), or the like; a high temperature solder of a zinc Zn system such as Zn₉₅Al₅ (melting point of 380° C.) or the like; a standard solder of a tin-lead system such as Sn₅Pb₉₅ (melting point of 300 to 314° C.), Sn₂Pb₉₈ (melting point of 316 to 322° C.), or the like; and a brazing filter material such as Au₈₈Ga₁₂ (melting point of 381° C.), or the like (all of the above suffixes indicate atom%).

In the case of joining three members such as cathode panel, anode panel, and joint member, they may be simultaneously joined or either the cathode panel or the anode panel may be joined with the joint member at the first stage and the other one of the cathode panel and the anode panel may be joined with the joint member at the second stage. If the simultaneous joining of those three members or the joining at the second stage is executed in a high vacuum atmosphere, the space surrounded by the cathode panel, anode panel, and joint member enters a vacuum state simultaneously with the joining. Or, after completion of the joining of those three members, the inside of the space surrounded by the cathode panel, anode panel, and joint member can be also exhausted and set into the vacuum state. In the case of exhausting after the joining, a pressure of the atmosphere upon joining may be equal to either the atmospheric pressure or the reduced pressure. A gas forming the atmosphere may be either the atmosphere or an inert gas containing a nitrogen gas or a gas (for example, Ar gas) belonging to Group 0 in a periodic table.

In the case of exhausting, the exhaustion can be executed through an exhaust pipe also called a tip pipe which has previously been connected to the cathode panel and/or the anode panel. Typically, the exhaust pipe is formed by a glass pipe or a hollow pipe made of a metal or an alloy [for example, an iron Fe alloy containing 42 weight % of nickel Ni or an iron Fe alloy containing 42 weight % of nickel Ni and 6 weight % of chromium Cr] each having a low coefficient of thermal expansion. By using the foregoing frit glass or metal material having the low melting point, the exhaust pipe is joined to the circumference of a piercing portion provided in an ineffective region of the cathode panel and/or the anode panel (region which surrounds, in a picture frame form, an effective region as a display region of a center portion serving as an actual function as a flat panel display apparatus). After the inside of the space reached a predetermined vacuum degree, the exhaust pipe is fully sealed by a thermal fusion or by being bonded with a pressure. If the whole flat panel display apparatus is temporarily heated and, thereafter, its temperature is reduced prior to sealing, the residual gas can be emitted into the space and a residual gas can be removed out of the space by the exhaustion. Therefore, such a method is preferable.

In the driving method of the flat panel display apparatus according to an embodiment of the invention, when at least the (1, N₁)-th first wiring is selected and the signal voltage Vₘ(1, N₁) is applied to each of the M second wirings, the predetermined voltage is applied to each of the M second wirings in the second second wiring group. That is, in the (1, N₁)-th horizontal scanning period just before the signal voltage Vₘ(2, 1) is applied to each of the M second wirings, the signal voltage Vₘ(1, N₁) has been applied to the first second wiring group and the predetermined voltage has also been applied to the second second wiring group. Therefore, in the (2, 1)-th horizontal scanning period, when the signal voltage Vₘ(2, 1) is applied to each of the M second wirings in the second second wiring group, since the second wirings have been in the pre-charged state, a dullness of the waveform of the signal voltage Vₘ(2, 1) which propagates in the second wirings (signal lines) is similar to a dullness of the waveform of the signal voltage Vₘ(1, N₁). Thus, a difference is difficult to occur between the display state in the image display portion in the (1, N₁)-th horizontal scanning period and the display state in the image display portion in the (2, 1)-th horizontal scanning period and the occurrence of the deterioration in display image quality in the flat panel display apparatus can be suppressed.

In the driving method of the flat panel display apparatus according to another embodiment of the invention, for a period of time until the first first wiring is selected after the Nth first wiring was selected, the predetermined voltage is applied to each of the M second wirings. Therefore, when the last horizontal scanning period is completed and the first horizontal scanning period in the next new display frame is started, the signal voltage is applied to each of the M second wirings. However, at this time, the M second wirings are in the pre-charged state. Thus, since it is similar to the charging state of the M second wirings in the second and subsequent horizontal scanning periods, a difference is difficult to occur between the display state in the image display portion in the first horizontal scanning period and the display state in the image display portion in the second horizontal scanning period and the occurrence of the deterioration in display image quality in the flat panel display apparatus can be suppressed.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1A is a conceptual diagram of a flat panel display apparatus in the embodiment 1;

FIG. 1B is a diagram schematically showing a state of dullness of a waveform of a signal which propagates in a second wiring (signal line) in the embodiment 1;

FIG. 1C is a diagram schematically showing a state of dullness of a waveform of a signal which propagates in a second wiring (signal line) in the related art;

FIG. 2 is a conceptual partial edge plane view of the flat panel display apparatus having spint type field emission devices; and

FIG. 3 is a schematic exploded perspective view of a portion of a cathode panel CP and an anode panel AP at the time when the cathode panel CP and the anode panel AP are exploded.

### DETAILED DESCRIPTION OF THE PREFERRED EMBODIMENTS

The invention will be described hereinbelow on the basis of an embodiment with reference to the drawings.

### Embodiment 1

An embodiment 1 relates to a driving method of a flat panel display apparatus according to the first embodiment of the invention. As a flat panel display apparatus in the embodiment 1 or an embodiment 2, which will be described hereinafter, a flat panel display apparatus in which electron emitting devices have been assembled, specifically speaking, a cold cathode electric field electron emitting display apparatus (hereinbelow, abbreviated to a display apparatus) as a flat panel display apparatus in which cold cathode electric field electron emitting devices have been assembled is used.

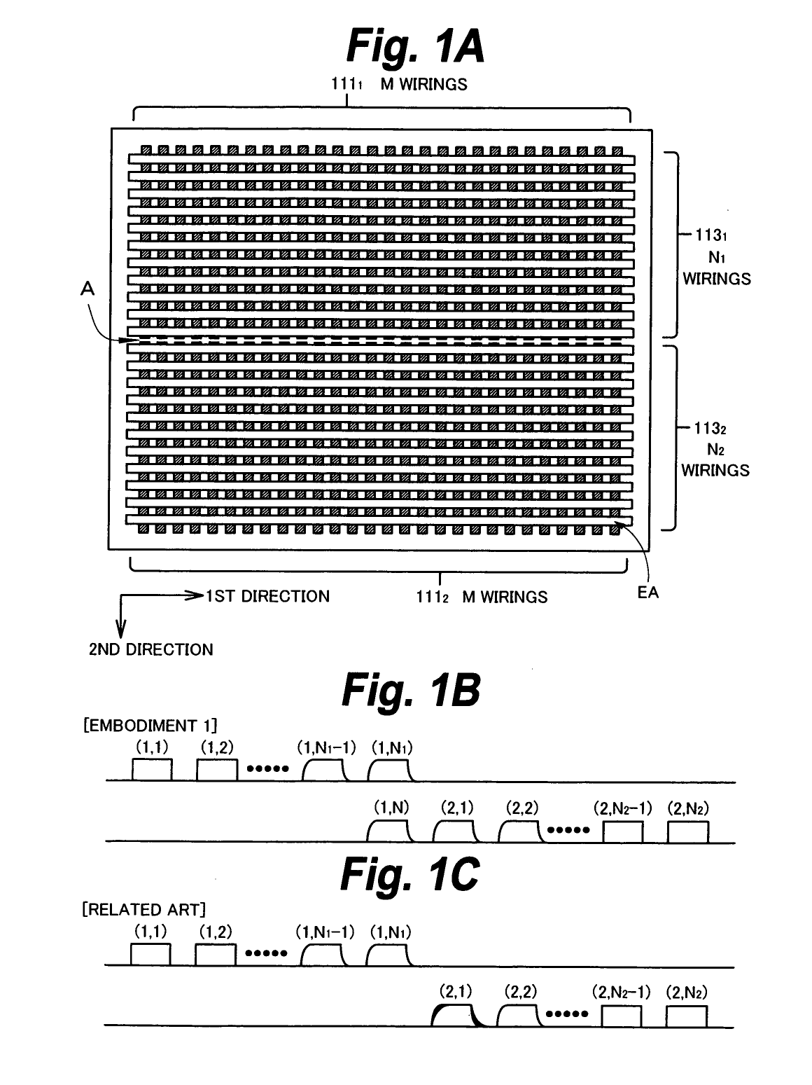

As shown in a conceptual diagram in FIG. 1A, the display apparatus in the embodiment 1 or embodiment 2, which will be described hereinafter, has:

(A) a first wiring group 113 (113₁, 113₂) constructed by N first wirings (specifically speaking, gate electrodes 13, which will be described hereinafter) extending in a first direction (specifically speaking, for example, horizontal direction);

(B) a second wiring group 111 (111₁, 111₂) constructed by (2×M) second wirings (specifically speaking, cathode electrodes 11, which will be described hereinafter) in such a manner that M virtual second wirings extending in a second direction (specifically speaking, for example, vertical direction) different from the first direction are divided into two parts along the first direction; and

(C) image display portions (specifically speaking, electron emitting regions EA, which will be described hereinafter) formed in overlapped regions of the first wirings and the second wirings.

In FIG. 1A, the second wiring groups 111_{‘}and 111₂ are shown by hatched portions in order to clarify the second wiring groups 111₁ and 111₂. In FIG. 1A, a region where the virtual second wirings have been divided into two parts along the first direction is shown by “A”. That is, the virtual second wirings have been divided into two parts in the region “A”. In the diagram, there is a case where the first direction is shown by the “X” direction and the second direction is shown by the “Y” direction.

The first wiring group 113 is constructed by a first first wiring group 113₁ having N₁ first wirings (gate electrodes 13) and a second first wiring group 113₂ having N₂ (where, N=N₁+N₂) first wirings (gate electrodes 13). The second wiring group 111 is constructed by: a first second wiring group 111₁ having M second wirings (cathode electrodes 11) which overlap the first first wiring group 113₁; and a second second wiring group 111₂ having M second wirings (cathode electrodes 11) which over lap the second first wiring group 113₂. In the embodiment 1 or embodiment 2, which will be described hereinafter, it is assumed that N₁=480, N₂=480, and M=3840.

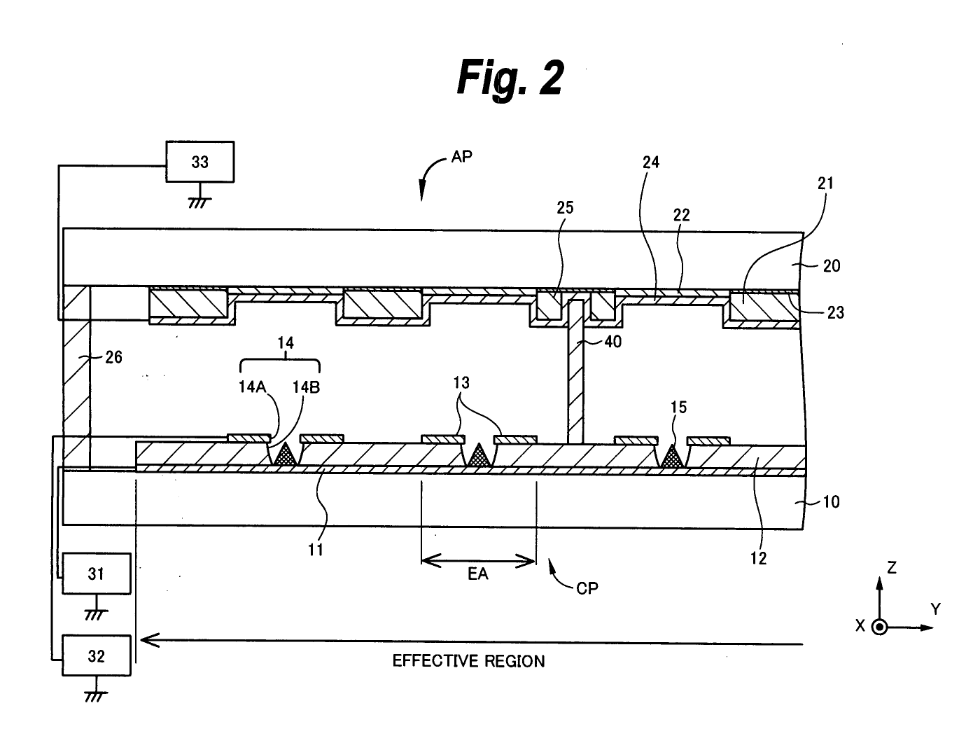

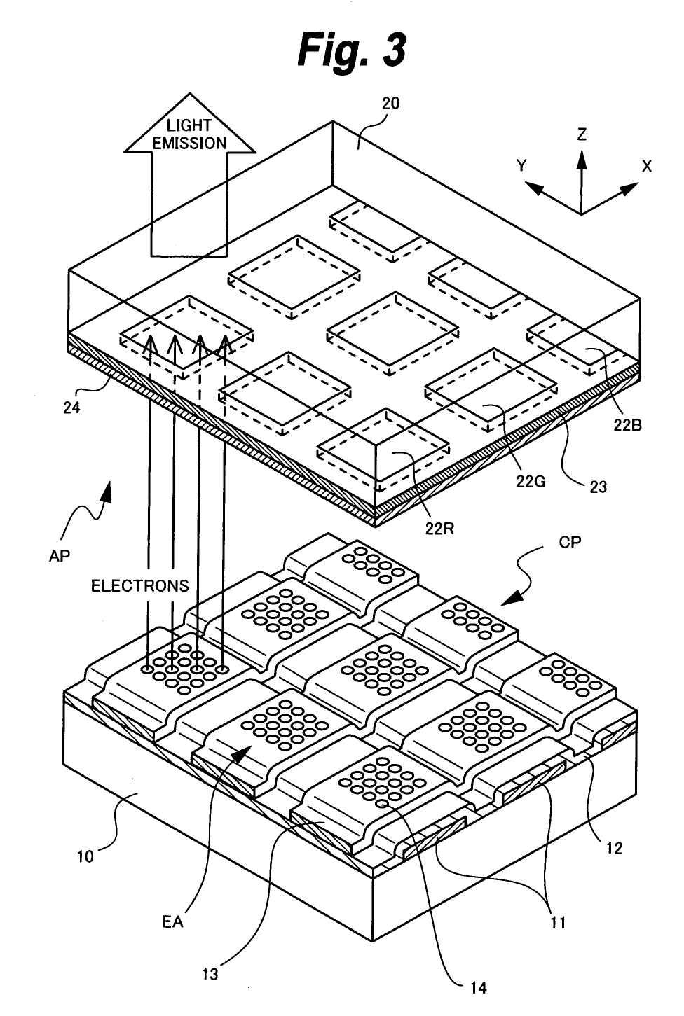

FIG. 2 shows a conceptual partial edge plane view of the display apparatus having spint type field emission devices as cold cathode electric field electron emitting devices (herein below, referred to as field emission devices) provided on the cathode electrodes in which conical electron emitting portions are located in bottom portions of opening portions. FIG. 3 shows a schematic exploded perspective view of a portion of a cathode panel CP and an anode panel AP at the time when the cathode panel CP and the anode panel AP are exploded. The cathode panel CP constructing the display apparatus has: the belt-shaped N gate electrodes (first wirings) 13 extending in the first direction (X direction in FIGS. 2 and 3); and the belt-shaped M cathode electrodes (second wirings) 11 extending in the second direction (Y direction in FIGS. 2 and 3) different from the first direction. The electron emitting region (image display portion) EA constructing one sub-pixel is formed in an overlapped region of each gate electrode 13 and each cathode electrode 11. The spint type field emission device constructing the display apparatus is formed by: the cathode electrode 11 formed on a supporting plate 10; an insulating layer 12 formed on the supporting plate 10 and the cathode electrode 11; the gate electrode 13 formed on the insulating layer 12; an opening portion 14 formed in the gate electrode 13 and the insulating layer 12 (a first opening portion 14A formed in the gate electrode 13 and a second opening portion 14B formed in the insulating layer 12); and a conical electron emitting portion 15 formed on the cathode electrode 11 locating in a bottom portion of the opening portion 14. The type of field emission device is not limited to the spint type field emission device but may be a flat type field emission device (field emission device in which an almost plane electron emitting portion is provided on the cathode electrode locating in the bottom portion of the opening portion).

Generally, the cathode electrode 11 and the gate electrode 13 are formed in the directions where projection images of the electrodes 11 and 13 cross perpendicularly. For convenience of explanation, in FIG. 2, a case where one electron emitting portion 15 provided in each electron emitting region EA is illustrated. Generally, the electron emitting regions EA are arranged in an effective region of the cathode panel CP (region corresponding to a display region of the display apparatus) in a 2-dimensional matrix form.

The anode panel AP has a structure in which phosphor regions 22 (specifically speaking, red light emission phosphor regions 22R, green light emission phosphor regions 22G, and blue light emission phosphor regions 22B) having a predetermined pattern are formed on a substrate 20 and the phosphor regions 22 are covered with anode electrodes 24. A region between the phosphor regions 22 is buried with a light absorbing layer (black matrix) 23 made of a light absorbing material such as carbon or the like, thereby preventing the occurrence of the color turbidity of the display image and the optical crosstalk. In the diagram, reference numeral 21 denotes a partition wall; 40 a spacer in, for example, a plate shape; 25 a spacer holding portion; and 26 a joint member. In FIG. 3, the partition wall, spacer, and spacer holding portion are not shown.

The anode electrode 24 has not only a function as a reflecting film for reflecting the light emitted from the phosphor region 22 but also a function for preventing the charging of the phosphor region 22. The partition wall 21 also has a function for preventing such a phenomenon that the electron recoiled from the phosphor region 22 or the secondary electron emitted from the phosphor region 22 (hereinbelow, such electrons are generally called backward scattering electrons) collides with another phosphor region 22 and what is called an optical crosstalk (color turbidity) occurs.

One sub-pixel is constructed by: the electron emitting region EA on the cathode panel side; and the phosphor region 22 on the anode panel side which faces a group of field emission devices. In the case of the color display apparatus, one picture element (one pixel) is constructed by a set of one red light emission phosphor region, one green light emission phosphor region, and one blue light emission phosphor region. Such M×(N/3) pixels are arranged in the effective region.

After the anode panel AP and the cathode panel CP were arranged so that the electron emitting region EA faces the phosphor region 22 and joined through the joint member 26 in a peripheral edge portion, the space surrounded by the cathode panel, anode panel, and joint member is exhausted and sealed, so that the display apparatus can be manufactured. The inside of the space surrounded by the anode panel AP, cathode panel CP, and joint member 26 is in a high vacuum state (for example, 1×10⁻³ Pa or less) In such a display apparatus, since the space surrounded by the anode panel AP, cathode panel CP, and joint member 26 is in the high vacuum state, if the spacer 40 in, for example, the plate shape is not arranged between the anode panel AP and the cathode panel CP, the display apparatus is damaged by the atmospheric pressure. The spacer 40 is made of a rigid material such as ceramics or the like.

A voltage which is relatively negative is applied to the cathode electrode 11 from a cathode electrode control circuit 31. A voltage which is relatively positive is applied to the gate electrode 13 from a gate electrode control circuit 32. A positive voltage which is further higher than that of the gate electrode 13 is applied to the anode electrode 24 from an anode electrode control circuit 33. In the case of displaying the image by the line-sequential driving system in such a display apparatus, a video signal is inputted to the cathode electrode (second wiring) 11 from the cathode electrode control circuit 31. A scan signal is inputted to the gate electrode (first wiring) 13 from the gate electrode control circuit 32. An electron is emitted from the electron emitting portion 15 on the basis of a quantum tunnel effect by an electric field caused when the voltage has been applied between the cathode electrode 11 and the gate electrode 13. The electron is attracted to the anode electrode 24, passes through the anode electrode 24, and collides with the phosphor region 22. Thus, the phosphor region 22 is excited and emits light, so that a desired image can be obtained. That is, the operation of the cold cathode electric field electron emitting display apparatus is fundamentally controlled by the voltage which is applied to the gate electrode 13 and the voltage which is applied to the cathode electrode 11. The cathode electrode 11 is driven by a cathode electrode driving driver. The gate electrode 13 is driven by a gate electrode driving driver. The cathode electrode control circuit 31, gate electrode control circuit 32, anode electrode control circuit 33, and those driving drivers can be constructed by well-known circuits, respectively.

In the embodiment 1, the display apparatus is driven by the line-sequential driving system in which the (1, 1)-th to (1, N₁)-th first wirings are sequentially selected and, subsequently, the (2, 1)-th to (2, N₂)-th first wirings are sequentially selected. The (2, 1)-th first wiring is adjacent to the (1, N₁)-th first wiring. When at least the (1, N₁)-th first wiring is selected and the signal voltage Vₘ(1, N₁) which specifies the luminance in the image display portion is applied to each of the M second wirings in the first second wiring group 111₁, a predetermined voltage is applied to each of the M second wirings in the second second wiring group 111₂. Specifically speaking, when the (1, N₁)-th first wiring is selected and the signal voltage Vₘ(1, N₁) is applied to each of the M second wirings [that is, in the (1, N₁)-th horizontal scanning period], a predetermined voltage is applied to each of the M second wirings in the second second wiring group 111₂. In the embodiment 1, it is assumed that the predetermined voltage is set to a voltage equal to the signal voltage [Vₘ(1, N₁)].

In the embodiment 1, when the (1, N₁)-th first wiring (gate electrode 13) is selected and the signal voltage Vₘ(1, N₁) is applied to each of the M second wirings (cathode electrodes 11), that is, a predetermined voltage is applied to each of the M second wirings in the second second wiring group 111₂ in the (1, N₁)-th horizontal scanning period. Therefore, when the signal voltage Vₘ(2, 1) is applied to each of the M second wirings (cathode electrodes 11) in the second second wiring group 111₂ in the (2, 1)-th horizontal scanning period, since the second wirings are in the pre-charged state, the dullness of the waveform of the signal voltage Vₘ(2, 1) which propagates in the second wirings (signal lines) is similar to the dullness of the waveform of the signal voltage Vₘ(1, N₁). Thus, a difference is difficult to occur between the display state in the image display portion in the (1, N₁)-th horizontal scanning period and the display state in the image display portion in the (2, 1)-th horizontal scanning period and the occurrence of the deterioration in display image quality in the flat panel display apparatus can be suppressed. FIG. 1B schematically shows a state of dullness of the waveform. Numerals shown in parentheses on the waveform indicate the horizontal scanning period of which designated number. In the related art schematically shown in FIG. 1C, as described above, the dullness of the waveform of the signal voltage Vₘ(2, 1) is large. A portion of a difference which is recognized when the waveform of the signal voltage Vₘ(2, 1) in the related art shown in FIG. 1C and the waveform of the signal voltage Vₘ(2, 1) in the embodiment 1 shown in FIG. 1B are overlaid is fully painted in black for clarification.

The predetermined voltage can be applied by controlling the operations in the cathode electrode control circuit 31 and the gate electrode control circuit 32. That is, it is sufficient that the voltage is applied to the (1, N₁)-th first wiring (gate electrode 13) by the operation of the gate electrode control circuit 32 and, at the same time, the signal voltage Vₘ(1, N₁) is applied to each of the M second wirings (cathode electrodes 11) in the first second wiring group 111₁ and to each of the M second wirings (cathode electrodes 11) in the second second wiring group 111₂ by the operation of the cathode electrode control circuit 31. In dependence on the period of time of the signal voltage Vₘ(1, N₁), the electrons are emitted from the electron emitting regions (image display portions) EA in the overlapped regions of the (1, N₁)-th first wiring (gate electrode 13) and the M second wirings (cathode electrodes 11) in the first second wiring group 111₁. On the other hand, since no voltage is applied to the (2, 1)-th first wiring (gate electrode 13), no electrons are emitted from the electron emitting regions (image display portions) EA in the overlapped regions of the (2, 1)-th first wiring (gate electrode 13) and the M second wirings (cathode electrodes 11) in the second second wiring group 111₂.

The gradation is controlled by the signal voltage. More specifically speaking, as a gradation control system, the following well-known gradation control systems can be used: a voltage modulation system (system in which when the gate electrodes are selected and scanned, the voltage which is applied to the cathode electrode is changed according to the gradation); a pulse width modulation system (PWM system in which the applied voltage to the cathode electrode is made constant, a pulse width of the applied voltage is varied, and the gradation is controlled with the elapse of time); and a pulse numbers modulation system (PNM system in which the applied voltage to the cathode electrode is made constant, the pulse width of the applied voltage is also made constant, and the gradation is controlled by the number of pulses of the applied voltage).

For example, the predetermined voltage may be applied to each of the M second wirings in the second second wiring group 111₂ in the (1, N₁-1)-th to (1, N₁)-th horizontal scanning periods, the (1, N₁-2)-th to (1, N₁)-th horizontal scanning periods, or the (1, N₁-3)-th to (1, N₁)-th horizontal scanning periods. As a predetermined voltage, a voltage equal to the signal voltage [Vₘ(2, 1)] or a preset dummy voltage V_{Dummy} can be also used.

### Embodiment 2

An embodiment 2 relates to a driving method of a flat panel display apparatus according to the second embodiment of the invention. The flat panel display apparatus in the embodiment 2 has substantially the same construction and structure as those of the flat panel display apparatus in the embodiment 1.

In the embodiment 2, the first wirings are driven by the line-sequential driving system in which the first to Nth first wirings (gate electrodes 13) are sequentially selected. The Nth first wiring is selected and, subsequently, the first first wiring is selected. For a period of time until the first first wiring (gate electrode 13) is selected after Nth first wiring (gate electrode 13) was selected, the predetermined voltage is applied to each of the M second wirings (cathode electrodes 11). That is, after the (1, N₁)-th horizontal scanning period in a certain frame was completed, before the first horizontal scanning period in the next certain frame is started, in other words, in a period of time corresponding to what is called a vertical blanking period, the predetermined voltage is applied to each of the M second wirings. In the embodiment 2, as a predetermined voltage, a voltage equal to a signal voltage [Vₘ(N)] is used.

As mentioned above, in the embodiment 2, after the last horizontal scanning period was completed, when the first horizontal scanning period in the next new display frame is started, the signal voltage is applied to each of the M second wirings (cathode electrodes 11). In this instance, the M second wirings are in the state where they have previously been charged by the voltage equal to the signal voltage [Vₘ(N)]. Thus, even in the first horizontal scanning period, the charging state is similar to the charging state of the M second wirings in the second and subsequent horizontal scanning periods. Therefore, a difference is difficult to occur between the display state in the image display portion in the first horizontal scanning period and the display state in the image display portion in the second horizontal scanning period and the occurrence of the deterioration in display image quality in the flat panel display apparatus can be suppressed. As a predetermined voltage, a voltage equal to a signal voltage [Vₘ(1)] or the preset dummy voltage V_{Dummy} may be used.

Although the invention has been described above with respect to the preferred embodiments, the invention is not limited to them. The constructions and structures of the flat panel display apparatus, cathode panel, anode panel, and field emission device described in the embodiments are shown as examples and can be properly changed. Although the flat panel display apparatus has been described mainly with respect to the color display as an example, a monochromatic display can be also performed. Although the cathode electrode has been set to the second wiring and the gate electrode has been set to the first wiring in the embodiments, the cathode electrode may be set to the first wiring and the gate electrode may be set to the second wiring in place of them.

Although the form in which one electron emitting portion corresponds to one opening portion has mainly been described in the field emission device, a proper one of the following forms can be also used depending on the structure of the field emission device: a form in which a plurality of electron emitting portions correspond to one opening portion; a form in which one electron emitting portion corresponds to a plurality of opening portions; and a form in which a plurality of first opening portions are formed in the gate electrode, a second opening portion communicated with the plurality of first opening portions regarding the insulating layer is formed, and one or plurality of electron emitting portions are formed.

The electron emitting region can be also constructed by an electron emitting device generally called a surface conduction electron emitting device. The surface conduction electron emitting device is constructed in such a manner that, for example, a number of pairs of electrodes each of which is made of a conductive material such as tin oxide SnO₂, gold Au, indium oxide In₂O₃/tin oxide SnO₂, carbon, palladium oxide PdO, or the like and has a very small area and which are arranged at a predetermined interval (gap) are formed in a matrix form on a supporting plate made of glass. A carbon thin film is formed on each of the electrodes. The surface conduction electron emitting device has a construction in which a row directional wiring is connected to one of the pair of electrodes and a column directional wiring is connected to the other one of the pair of electrodes. By applying a voltage to the pair of electrodes, an electric field is applied to the carbon thin films which face through a gap and an electron is emitted from the carbon thin film. By allowing the electron to collide with the phosphor region on the anode panel, the phosphor region is excited and emits light, so that a desired image can be obtained. It is sufficient that the pair of electrodes are constructed by the gate electrode and the cathode electrode. Or, the electron emitting region can be also constructed by a metal/insulating film/metal type device.

Further, a liquid crystal display apparatus (LCD), an electroluminescence display apparatus (ELD), or a plasma display apparatus (PDP) can be also mentioned as a flat panel display apparatus.

It should be understood by those skilled in the art that various modifications, combinations, sub-combinations and alterations may occur depending on design requirements and other factors insofar as they are within the scope of the appended claims or the equivalents thereof.

What is claimed is:

1. A driving method of a flat panel display apparatus of a line-sequential driving system, in which the display apparatus comprises:
(A) a first wiring group having N first wirings extending in a first direction;
(B) a second wiring group constructed by (2×M) second wirings in such a manner that M virtual second wirings extending in a second direction different from the first direction are divided into two parts along the first direction; and
(C) image display portions formed in overlapped regions of the first wirings and the second wirings,
the first wiring group is constructed by a first first wiring group having N₁ first wirings and a second first wiring group having N₂ (where, N=N₁+N₂) first wirings,
the second wiring group is constructed by a first second wiring group having M second wirings which overlap the first first wiring group and a second second wiring group having M second wirings which overlap the second first wiring group, and
the first to N₁-th first wirings in the first first wiring group are sequentially selected and, subsequently, the first to N₂-th first wirings in the second first wiring group are sequentially selected,
whereby when at least the N₁-th first wiring is selected in the first first wiring group and a voltage which specifies a luminance in the image display portion is applied to each of the M second wirings in the first second wiring group, a predetermined voltage is applied to each of the M second wirings in the second second wiring group.

2. The driving method of the flat panel display apparatus according to claim 1, wherein said predetermined voltage is a voltage which is equal to the voltage at the time when the N₁-th first wiring is selected in the first first wiring group and the voltage which specifies the luminance in the image display portion is applied to each of the M second wirings in the first second wiring group.

3. The driving method of the flat panel display apparatus according to claim 1, wherein said predetermined voltage is a voltage which is equal to the voltage at the time when the first first wiring is selected in the second first wiring group and the voltage which specifies the luminance in the image display portion is applied to each of the M second wirings in the second second wiring group.

4. The driving method of the flat panel display apparatus according to claim 1, wherein said predetermined voltage is a preset dummy voltage.

5. A driving method of a flat panel display apparatus of a line-sequential driving system, in which the display apparatus comprises:
(A) N first wirings extending in a first direction;
(B) M second wirings extending in a second direction different from the first direction; and
(C) image display portions formed in overlapped regions of the first wirings and the second wirings, and
the first to Nth first wirings are sequentially selected,
where by a predetermined voltage is applied to each of the M second wirings for a period of time until the first first wiring is selected after the Nth first wiring was selected.

6. The driving method of the flat panel display apparatus according to claim 5, wherein said predetermined voltage is a voltage which is equal to the voltage at the time when the Nth first wiring is selected and the voltage which specifies the luminance in the image display portion is applied to each of the M second wirings.

7. The driving method of the flat panel display apparatus according to claim 5, wherein said predetermined voltage is a voltage which is equal to the voltage at the time when the first first wiring is selected and the voltage which specifies the luminance in the image display portion is applied to each of the M second wirings.

8. The driving method of the flat panel display apparatus according to claim 5, wherein said predetermined voltage is a preset dummy voltage.
